(19) United States
(12) Patent Application Publication
(10) Pub. No.: US 2008/0021858 A1
(43) Pub. Date: Jan. 24, 2008

(54) METHOD FOR RULES BASED DEFAULT BROWSER HOMEPAGE

(75) Inventor: Blaine H. Dolph, Western Springs, IL (US)

Correspondence Address: CANTOR COLBURN LLP - IBM AUSTIN, 55 GRIFFIN ROAD SOUTH, BLOOMFIELD, CT, 06002, US

(73) Assignee: International Business Machines Corporation, Armonk, NY (US)

(21) Appl. No.: 11/458,786

(22) Filed: Jul. 20, 2006

(51) Int. Cl. G06F 17/30

(52) U.S. Cl. 707/1

(57) ABSTRACT

A method for allowing a user to access des₂₆ome pages by using a rules engine that links Uniform Resource Locators (URLs) to a time range; allowing the user to open a web browser; generating a request to access the plurality of home pages in response to launching the web browser; and retrieving the desired home pages from the web browser based on a relationship between the time range and the URLs predefined by the user.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to web home pages, and particularly to a method for dynamically changing a default home page for a web browser.

2. Description of Background

Web browsers, such as Netscape Navigator and/or Microsoft Internet Explorer (MSIE) provide graphical user interface (GUI) based client applications that implement the client side portion of the Hypertext Transfer Protocol (HTTP) protocol. One format for information transfer is to create documents using Hypertext Markup Language (HTML). HTML pages are made up of standard text as well as formatting codes that indicate how the page should be displayed. Web browsers read these codes in order to display the page.

A network resource identifier such as a Uniform Resource Identifier (URI) is a compact string of characters for identifying an abstract or physical resource. URI is the generic set of all names and addresses that refer to objects on the Internet. URIs that refer to objects accessed with existing protocols are known as Uniform Resource Locators (URLs). A URL is the address of a file accessible on the Internet. The URL includes the name of the protocol required to access the resource, a domain name, or Internet Protocol (IP) address that identifies a specific computer on the Internet, and a hierarchical description of a file location on the computer.

Everyone who uses the Internet opens several browser windows many times over the course of a day. For most people, this brings up the default homepages of each web site accessed. Web browsers allow a person to select a URL that points to a default homepage. This homepage is retrieved each time a person opens a web window. The problem is that as a person goes through the day accessing several web sites, this person desires to use a different web page as a default during different time periods of the day. In order to change the default web page, what a person is required to do is to bring up the web browser and manually choose a bookmark or type in a different URL as a default. As a result, this is a very time consuming and inefficient manner of changing default web pages.

Considering the limitations of the aforementioned methods, it is clear that there is a need for a method for dynamically changing a default home page for a web browser. Therefore, a “Rules Engine” containing multiple start times and URLs for determining user designated default home pages is highly desirable.

### SUMMARY OF THE INVENTION

The shortcomings of the prior art are overcome and additional advantages are provided through the provision of a method for accessing a plurality of home pages, the method comprising: allowing a user to access desired home pages by using a rules engine that links Uniform Resource Locators (URLs) to a time range; allowing the user to open a web browser; generating a request to access the plurality of home pages in response to launching the web browser; and retrieving the desired home pages from the web browser based on a relationship between the time range and the URLs predefined by the user.

The shortcomings of the prior art are overcome and additional advantages are provided through the provision of a system for accessing a plurality of home pages, the system comprising: a network; and a host system in communication with the network, the host system including software to implement a method comprising: allowing a user to access desired home pages by using a rules engine that links Uniform Resource Locators (URLs) to a time range; allowing the user to open a web browser; generating a request to access the plurality of home pages in response to launching the web browser; and retrieving the desired home pages from the web browser based on a relationship between the time range and the URLs predefined by the user.

The shortcomings of the prior art are overcome and additional advantages are provided through the provision of a computer program product for accessing a plurality of home pages, the computer program product comprising: allowing a user to access desired home pages by using a rules engine that links Uniform Resource Locators (URLs) to a time range; allowing the user to open a web browser; generating a request to access the plurality of home pages in response to launching the web browser; and retrieving the desired home pages from the web browser based on a relationship between the time range and the URLs predefined by the user.

Additional features and advantages are realized through the techniques of the present invention. Other embodiments and aspects of the invention are described in detail herein and are considered a part of the claimed invention. For a better understanding of the invention with advantages and features, refer to the description and the drawings.

### Technical Effects

As a result of the summarized invention, technically we have achieved a solution that provides for a method for dynamically changing a default home page for a web browser.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a daily rules table according to the exemplary embodiments of the present invention; and

FIG. 2 illustrates one example of a general rules table according to the exemplary embodiments of the present invention.

### DETAILED DESCRIPTION OF THE INVENTION

One aspect of the exemplary embodiments is a method for dynamically changing a default home page for a web browser. The exemplary embodiments of the present invention link the web browser to a “Rules Engine” containing multiple start times and Uniform Resource Locators (URLs) for determining user designated default home pages.

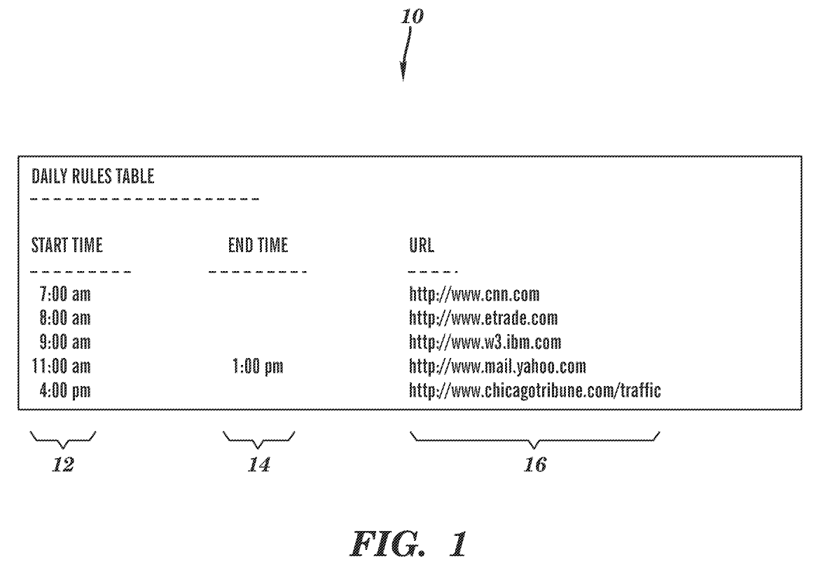

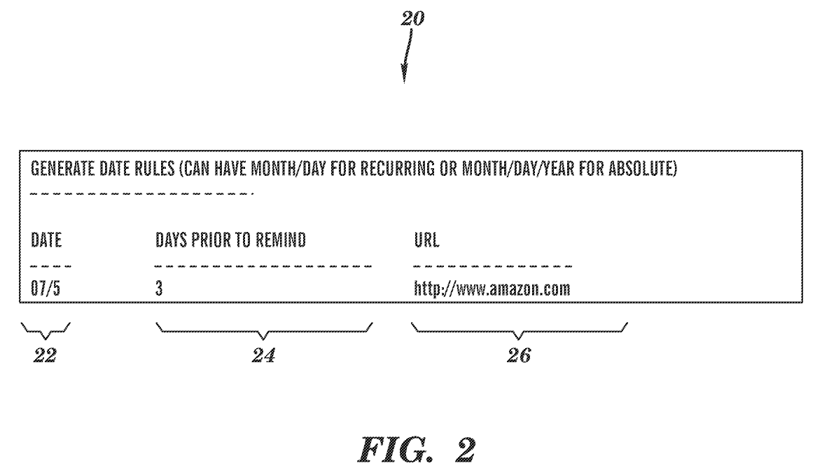

The exemplary embodiments of the present invention implement a method for the web browser to interface with a rules engine to determine the desired homepage to display for a specific user when that user launches their web browser. The rules engine can be as complex as desired by the end user. A simple implementation would be a time-based daily or general table where a certain daily time range would link to a URL (as described below with reference to FIGS. 1 and 2). In addition, a specific date may link to a URL.

For example, in the morning, say at 7:00 a.m., a person may want to bring up a first web site to read the latest news. At, say 8:00 a.m., a person might want to bring up a second web site to check on a stock portfolio. At 9:00 a.m. a person may want to check the company intranet site and set it as a default. Furthermore, between 11:00 a.m. and 1:00 p.m., a person may want to check email via a web site that provides email access. In addition, at say 4:00 p.m., a person may want a page that shows traffic congestion to be set as a default web page. Therefore, a user may wish to designate several web pages as defaults throughout the day depending on the time of day or even on specific days.

In order to accomplish this task, a datastore is set up to hold daily or general rules that are predefined by a user. For example for a date-based rules engine there may be two tables. One for daily rules and one for general date rules, as shown in FIGS. 1 and 2.

Referring to FIG. 1, a daily rules table 10 is shown. The daily rules table 10 includes three columns. Column 1 is the start time column 12, column 2 is the end time column 14, and column 3 is the URL column 16. The start time column 12 indicates the time at which a user designated a certain web site to be the default web site. For example, at 7:00 a.m. in the morning, the user designated the URL http://www.cnn.com to be the default web site when the user opens a web browser. If the user opens a web browser at 9:00 a.m., then the default web page is http://w3.ibm.com. Therefore, the user is in a position to designate which web page is a default web page based on a rules engine that is time-based throughout the day or week or month or year. The user is also permitted to enter an end time via the end time column 14. In other words, a user may indicate a specific range during which a web page is set as a default web page. For example, between 11:00 a.m. and 1:00 p.m., the user designated http://mail.yahoo.com to be the desired default web page.

Referring to FIG. 2, a general rules table 20 is shown. The general rules table 20 includes three columns. Column 1 is the date column 22, column 2 is the days prior to remind column 24, and column 3 is the URL column 26. The date column 22 indicates the date at which a certain predefined web page is desired to be displayed as a default web page. The days prior to remind indicates that a notification is sent to the user 3 days prior to when web page is displayed as the default web page. The URL column designates the web page to be displayed as a default web page on that specific date. For example, in table 20 of FIG. 2, the user designated that the web page http://www.amazon.com be displayed as a default webpage on July 5 and that the user be notified of this event three days prior to this event occurring.

As a result, the control program of the exemplary embodiments performs the following steps. First, a user opens a web browser. Then the control program calls the rules engine. If the rules engine returns a URL, then the web browser is directed to that URL. If no rule is met, then the web browser defaults to a default web page set for the web browser. As a result, the web browser uses the default setting during that time period. Consequently, the exemplary embodiments of the present invention permit a user to designate several web pages as default web pages throughout a day, a week, a month or even a year based on a time-based rules engine defined by the user.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for accessing a plurality of home pages, the method comprising:
allowing a user to access desired home pages by using a rules engine that links Uniform Resource Locators (URLs) to a time range;
allowing the user to open a web browser;
generating a request to access the plurality of home pages in response to launching the web browser; and
retrieving the desired home pages from the web browser based on a relationship between the time range and the URLs predefined by the user.

2. The method of claim 1, wherein the time range is a daily time range.

3. The method of claim 1, wherein the time range is a general time range.

4. A system for accessing a plurality of home pages, the system comprising:
a network; and
a host system in communication with the network, the host system including software to implement a method comprising:
allowing a user to access desired home pages by using a rules engine that links Uniform Resource Locators (URLs) to a time range;
allowing the user to open a web browser;
generating a request to access the plurality of home pages in response to launching the web browser; and
retrieving the desired home pages from the web browser based on a relationship between the time range and the URLs predefined by the user.

5. The system of claim 1, wherein the time range is a daily time range.

6. The system of claim 1, wherein the time range is a general time range.

7. A computer program product for accessing a plurality of home pages, the computer program product comprising:
a storage medium readable by a processing circuit and storing instructions for execution by the processing circuit for performing a method comprising:
allowing a user to access desired home pages by using a rules engine that links Uniform Resource Locators (URLs) to a time range;
allowing the user to open a web browser;
generating a request to access the plurality of home pages in response to launching the web browser; and
retrieving the desired home pages from the web browser based on a relationship between the time range and the URLs predefined by the user.
